(19) United States
(12) Patent Application Publication
(10) Pub. No.: US 2002/0027210 A1
(43) Pub. Date: Mar. 7, 2002

(54) Image information reading apparatus

(75) Inventor: Satoshi Arakawa, Odawara-shi (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: FUJI PHOTO FILM CO., LTD.

(21) Appl. No.: 09/931,064

(22) Filed: Aug. 17, 2001

(30) Foreign Application Priority Data
Aug. 18, 2000 (JP) 2000-248265

(51) Int. Cl. G03B 42/08

(52) U.S. Cl. 250/584

(57) ABSTRACT

An image information reading apparatus which is relatively small in size and weight has a laser beam applying device for applying a laser beam to a stimulable phosphor sheet inserted into an apparatus housing, and a light collecting device for collecting light that is emitted from the stimulable phosphor sheet upon exposure to the laser beam. The laser beam applying device and the light collecting device are displaced in unison with each other over the entire length of the stimulable phosphor sheet by a displacing mechanism.

### BACKGROUND OF THE INVENTION

1. Field of the Invention

The present invention relates to an image information reading apparatus for reading radiation image information recorded on a stimulable phosphor sheet by applying stimulating light to the stimulable phosphor sheet.

2. Description of the Related Art

There is known a system for temporarily recording radiation image information of a subject such as a human body, and reproducing the recorded radiation image information on a photosensitive medium such as a photographic film, or displaying the recorded radiation image information as a visible image on a display device. The system employs a stimulable phosphor as a recording medium for temporarily recording the radiation image information.

The stimulable phosphor is a phosphor which, when exposed to an applied radiation (X-rays, α-rays, γ-rays, electron beams, ultraviolet radiation, or the like), stores a part of the energy of the radiation, and, when subsequently exposed to applied stimulating rays such as visible light, emits light in proportion to the stored energy of the radiation. Usually, a sheet provided with a layer of the stimulable phosphor is used as a stimulable phosphor sheet.

The above known system comprises an image information reading apparatus which comprises a reading unit for reading the recorded radiation image information from the stimulable phosphor sheet, and an erasing unit for erasing remaining radiation image information from the stimulable phosphor sheet after the reading unit has read the recorded radiation image information. The image information reading apparatus has a loading unit for accommodating a cassette which stores a stimulable phosphor sheet with the radiation image information of a subject being recorded thereon by an external imaging device.

The cassette comprises a cassette casing and a lid mounted on the cassette casing by a pivot for swinging movement about the pivot. When the lid is swung about the pivot, the cassette casing is opened or closed. With the cassette casing being open, the stimulable phosphor sheet is removed from the cassette by a sheet handling mechanism and then fed toward the reading unit by a sheet feeding mechanism.

The reading unit is usually disposed vertically downwardly of the loading unit. The stimulable phosphor sheet is fed horizontally from the loading unit by the sheet feeding mechanism, then fed along a curved path and then downwardly, and fed along a curved path and then horizontally again before the stimulable phosphor sheet reaches the reading unit.

The reading unit has a laser beam applying device and a light collecting device. The light collecting device comprises a photoelectric transducer with a built-in photoelectric transducer mechanism, and a light guide for guiding light emitted from the stimulable phosphor sheet to the photoelectric transducer. The light guide is made of acrylic resin or the like, and includes a flat portion disposed in confronting relation to the stimulable phosphor sheet and a curved and tapered portion directed toward the photoelectric transducer. The photoelectric transducer is mounted on the tip end of the curved and tapered portion of the light guide.

The laser beam applying device applies a laser beam to an image recording surface of the stimulable phosphor sheet. Upon exposure to the laser beam, the image recording surface emits light representative of the recorded image information. The emitted light is applied to the light guide, and guided by the light guide to the photoelectric transducer, which converts the light to an electric signal. The electric signal is outputted from the photoelectric transducer to a display unit, for example, which converts the electric signal to a light signal and outputs the light signal as an image.

The stimulable phosphor sheet from which the desired image information has been read by the reading unit is sent to the erasing unit, which erases unwanted remaining image information from the stimulable phosphor sheet. The stimulable phosphor sheet fed from the erasing unit is inserted back into the cassette in the loading unit by the sheet handling mechanism, and will be used again.

The image information reading apparatus incorporates the sheet handling mechanism and the sheet feeding mechanism in addition to the reading unit and the erasing unit. Therefore, the image information reading apparatus is relatively large in size and heavy.

### SUMMARY OF THE INVENTION

It is a general object of the present invention to provide an image information reading apparatus which does not require a sheet handling mechanism and a sheet feeding mechanism and hence which is relatively small in size and weight.

A major object of the present invention is to provide an image information reading apparatus which does not incorporate a sheet handling mechanism for removing a stimulable phosphor sheet from and inserting a stimulable phosphor sheet into a cassette and a sheet feeding mechanism for feeding a stimulable phosphor sheet, and which is much smaller and lighter than the conventional image information reading apparatus.

Another object of the present invention is to provide an image information reading apparatus which has a lifting and lowering mechanism for moving a light collecting device toward a stimulable phosphor sheet for an increased light collecting efficiency and an increased image S/N ratio.

Still another object of the present invention is to provide an image information reading apparatus which allows a light collecting device and a stimulable light applying device to be displaced in unison with each other without a displacing mechanism for displacing the light collecting device.

Yet another object of the present invention is to provide an image information reading apparatus which does not incorporate a lid opening and closing mechanism for opening and closing a lid and which is relatively small in size and weight.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of an image information reading apparatus according to the present invention;

FIG. 2 is a front elevational view of the image information reading apparatus shown in FIG. 1;

FIG. 3 is an enlarged side elevational view, partly in cross section, of a lifting and lowering mechanism of the image information reading apparatus shown in FIG. 1;

FIG. 4 is a perspective view of a cassette for storing a stimulable phosphor sheet therein; and

FIG. 5 is a front elevational view showing the positions of parts of the image information reading apparatus at the time a laser beam applying device and a light collecting device are displaced.

### DESCRIPTION OF THE PREFERRED EMBODIMENT

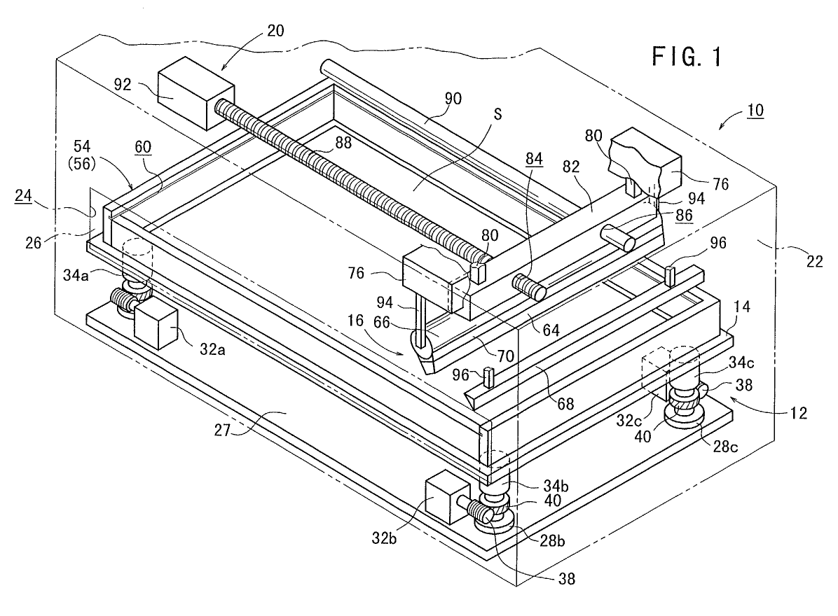

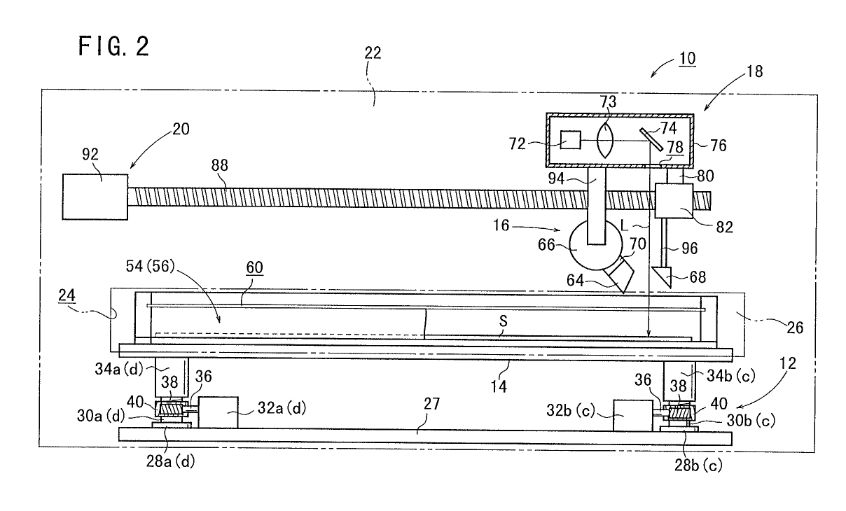

As shown in FIGS. 1 and 2, an image information reading apparatus 10 according to the present invention comprises a lifting and lowering mechanism 12, a support table 14 which can be lifted and lowered by the lifting and lowering mechanism 12, a light collecting device 16, a laser beam applying device 18 (see FIG. 2) as a stimulating light applying means to which the light collecting device 16 is coupled, and a displacing mechanism 20 (see FIG. 1) for displacing the laser beam applying device 18. The lifting and lowering mechanism 12, the support table 14, the light collecting device 16, the laser beam applying device 18, and the displacing mechanism 20 are housed in an apparatus housing 22. The apparatus housing 22 has an opening 24 defined in a side wall thereof with a shutter 26 disposed therein. The shutter 26 can be moved vertically by a shutter opening and closing mechanism, not shown, for opening or closing the opening 24.

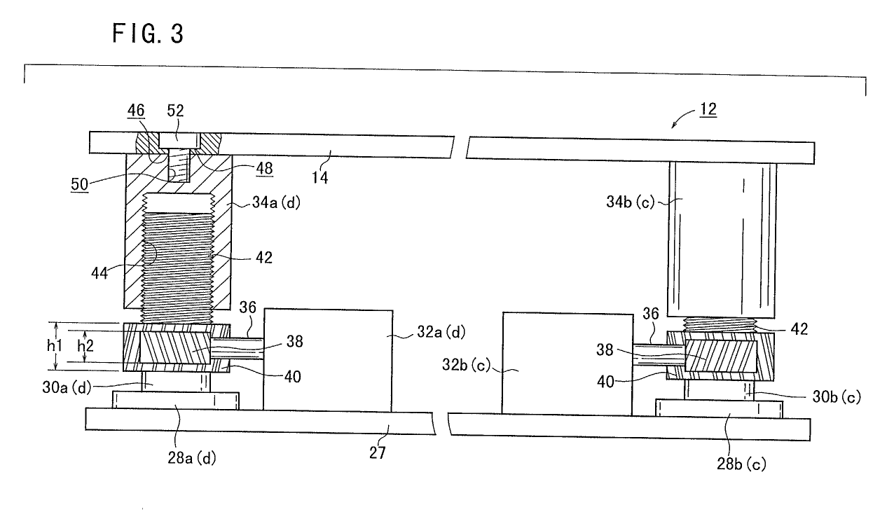

As shown at an enlarged scale in FIG. 3, the lifting and lowering mechanism 12 comprises four bearings 28a, 28b, 28c, 28d fixedly mounted on a base 27 placed on the bottom panel of the apparatus housing 22, four vertical support shafts 30a, 30b, 30c, 30d rotatably supported by the respective bearings 28a, 28b, 28c, 28d, and four motors 32a, 32b, 32c, 32d mounted on the base 27 for rotating the support shafts 30a, 30b, 30c, 30d, respectively. The support shafts 30a, 30b, 30c, 30d have upper end portions threaded in respective brackets 34a, 34b, 34c, 34d positioned beneath and fastened to the support table 14.

The motor 32a has a rotatable shaft 36 with a worm 38 fitted thereon which is held in mesh with a worm gear 40 fitted over the support shaft 30a beneath the bracket 34a. The height h1 of the worm gear 40 is larger than the height h2 of the worm 38.

The upper end portion of the support shaft 30a has an externally threaded surface 42. The bracket 34a has an internally threaded surface 44. The support shaft 30a and the bracket 34a are relatively movably coupled to each other by the externally threaded surface 42 and internally threaded surface 44 which are held in mesh with each other.

The support shafts 30b, 30c, 30d, the motors 32b, 32c, 32d, and the brackets 34b, 34c, 34d are identical in structure to the support shaft 30a, the motor 32a, and the bracket 34a. Those parts of the support shafts 30b, 30c, 30d, the motors 32b, 32c, 32d, and the brackets 34b, 34c, 34d which are identical to those of the support shaft 30a, the motor 32a, and the bracket 34a are denoted by identical reference characters, and will not be described in detail below.

The support table 14 has four recesses 48 defined respectively in the upper surfaces of four corners thereof and four through holes 46 defined therein in communication with the respective recesses 48. The brackets 34a, 34b, 34c, 34d have respective bolt holes 50 defined in upper ends thereof in vertical alignment with the through holes 46. Bolts 52 are threaded through the respective through holes 46 into the respective bolt holes 50. The bolts 52 have respective heads seated on the bottoms of the recesses 48. The brackets 34a, 34b, 34c, 34d coupled to the support base 14 by the bolts 52 support the support base 14 at its four corners. The heads of the bolts 52 are fully received in the respective recesses 48 and have respective upper surfaces lying flush with the upper surface of the support base 14.

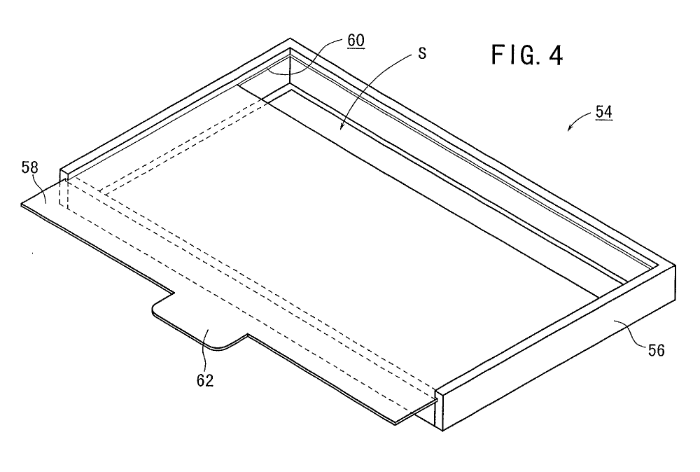

As shown in FIG. 4, a cassette (container) 54 housing a stimulable phosphor sheet S is placed on the support table 14.

The cassette 54 has a cassette casing 56 and a lid 58 removably mounted on the cassette casing 56, with the stimulable phosphor sheet S housed in the cassette casing 56. The cassette casing 56 has grooves 60 defined in inner side wall surfaces. The lid 58 has side edges slidably fitted in the grooves 60 in the cassette casing 56. The lid 58 has a tab 62 projecting from a substantially central portion of a side edge other than those side edges which are slidably fitted in the grooves 60. The lid 58 is removed from and installed on the cassette casing 56 after the cassette 54 has been inserted into the apparatus housing 22.

As shown in FIGS. 1 and 2, the light collecting device 16 comprises a light guide 64 made of a light-transmissive material such as glass, acrylic resin, or the like, a photomultiplier 66 with a built-in photoelectric transducer mechanism, and a reflecting mirror 68. The photomultiplier 66 is mounted on an upper end of the light guide 64 with a stimulating light separating filter 70 interposed therebetween.

The light guide 64 is disposed such that its lower distal end is positioned near a location where a laser beam L is applied by the laser beam applying device 18. When the laser beam L is applied to the stimulable phosphor sheet S in the cassette casing 56 by the laser beam applying device 18, light is emitted from the stimulable phosphor sheet S and guided by the light guide 64 toward the photomultiplier 66. In the photomultiplier 66, the light is converted to an electric signal by the built-in photoelectric transducer mechanism.

The reflecting mirror 68 is disposed in confronting relation to the light guide 64 across the laser beam L. As described later on, light emitted from the stimulable phosphor sheet S in a direction opposite to the light guide 64 is reflected by the reflecting mirror 68 toward the light guide 64 and finally guided by the light guide 64 toward the photomultiplier 66.

As shown in FIG. 2, the laser beam applying device 18 comprises a laser beam source 72, a lens system 73 for converging the laser beam L emitted from the laser beam source 72, a laser beam reflecting mirror 74 for reflecting the converged laser beam L, and a box 76 which accommodates the laser beam source 72, the lens system 73, and the laser beam reflecting mirror 74. The box 76 has an aperture 78 defined in a bottom wall thereof. The laser beam L reflected by the laser beam reflecting mirror 74 is directed out of the box 76 through the aperture 78 downwardly toward the stimulable phosphor sheet S in the cassette 54.

The laser beam applying device 18 can be displaced in the apparatus housing 22 by the displacing mechanism 20. Specifically, a guide member 82 is coupled to a lower surface of the box 76 by two laterally spaced joint plates 80 (see FIGS. 1 and 2). The displacing mechanism 20 has a ball screw 88 and a linear guide 90 (see FIG. 1) that extend parallel to each other through a threaded hole 84 and a through hole 86, respectively, which are defined in the guide member 82.

The displacing mechanism 20 also has a motor 92 coupled to an end of the ball screw 88 for rotating the ball screw 88 about its own axis. When the ball screw 88 is rotated about its own axis, the guide member 82 is displaced along the ball screw 88 and the linear guide 90, and hence the box 76, i.e., the laser beam applying device 18, is also displaced along the ball screw 88 and the linear guide 90.

The photomultiplier 66 is coupled to the box 76 by two laterally spaced first joints 94, and the reflecting mirror 68 is coupled to the box 76 by two laterally spaced second joints 96 and the guide member 82. The motor 92 and the linear guide 90 are rigidly supported by a frame, not shown, that is disposed in the apparatus housing 22.

The image information reading apparatus 10 is basically constructed as described above. Operation of the image information reading apparatus 10 will now be described below.

For reading radiation image information recorded on the stimulable phosphor sheet S with the image information reading apparatus 10, the operator performs a certain preparatory action, described below, and operates the image information reading apparatus 10.

The operator actuates the shutter opening and closing mechanism to lift the shutter 26 to open the opening 24 of the image information reading apparatus 10, and places the cassette 54 which houses the stimulable phosphor sheet S with the radiation image information of a subject being recorded thereon by an external imaging device, not shown, on the support table 14. Since the heads of the bolts 52 are fully received in the respective recesses 48 and do not project from the upper surface of the support table 14, the bolts 52 do not obstruct the placement of the cassette 54 on the support table 14.

The operator then grips and pulls the tab 62 (see FIG. 4) of the lid 58 of the cassette 54, moving the lid 58 along the grooves 60 until the lid 58 is released from the cassette casing 56. When the lid 58 is removed, the image recording surface of the stimulable phosphor sheet S in the cassette casing 56 is exposed upwardly.

Then, the operator actuates the shutter opening and closing mechanism to lower the shutter 26. The operator energizes the laser beam applying device 18 to emit the laser beam L from the laser beam source 72. The laser beam L is converged by the lens system 73, reflected by the laser beam reflecting mirror 74, directed downwardly out of the box 76 via the aperture 78, and applied substantially perpendicularly to the image recording surface of the stimulable phosphor sheet S.

Upon exposure to the laser beam L, the image recording surface of the stimulable phosphor sheet S emits light representing the recorded radiation image information. The light emitted toward the light guide 64 is directly guided by the light guide 64 of the light collecting device 16. The light emitted away from the light guide 64 is reflected by the reflecting mirror 68 toward the light guide 64, and then guided by the light guide 64.

The light is then guided through the light guide 64 to the stimulating light separating filter 70. The stimulating light separating filter 70 removes a light component representing noise from the light, which is then applied to the photomultiplier 66.

In the photomultiplier 66, the light is converted by the built-in photoelectric transducer mechanism to an electric signal, which is outputted to the display unit. The display unit converts the electric signal to a light signal and outputs the light signal as an image.

After the image has been obtained, the motors 32a, 32b, 32c, 32d of the lifting and lowering mechanism 12 (see FIG. 3) are simultaneously energized to rotate the respective rotatable shafts 36 about their own axes. The rotatable shafts 36 rotate the worms 38 and the worm gears 40, rotating the support shafts 30a, 30b, 30c, 30d about their vertical axes.

As described above, the support shafts 30a, 30b, 30c, 30d and the brackets 34a, 34b, 34c, 34d are coupled to each other by the externally threaded surface 42 and internally threaded surface 44 which are held in mesh with each other. Therefore, when the support shafts 30a, 30b, 30c, 30d are rotated about vertical axes, they axially move relatively to the brackets 34a, 34b, 34c, 34d, i.e., in a direction into the brackets 34a, 34b, 34c, 34d or in a direction out of the brackets 34a, 34b, 34c, 34d. Since the support shafts 30a, 30b, 30c, 30d are actually axially immovable, the brackets 34a, 34b, 34c, 34d are lifted or lowered, thus lifting or lowering the support table 14. The height hi of the worm gear 40 is larger than the height h2 of the worm 38. Consequently, the worm 38 is prevented from being displaced out of mesh with the worm gear 40 upon vertical movement of the brackets 34a, 34b, 34c, 34d.

When the support table 14 is lowered, the light collecting device 16 is moved closely to the stimulable phosphor sheet S (see FIG. 1) for an increased light collecting efficiency and an increased image S/N ratio.

After the support table 14 is lowered, the motor 92 is energized to rotate the ball screw 88 about its own axis to displace the guide member 82 from a position above a front end of the stimulable phosphor sheet S along the linear guide 90 toward the motor 92. The box 76 coupled to the guide member 82 is also displaced, and hence the photomultiplier 66, the light guide 64, and the reflecting mirror 68 are also displaced, toward the motor 92, because the photomultiplier 66 and the light guide 64 are coupled to the box 76 by the first joints 94 and the reflecting mirror 68 is coupled to the box 76 by the second joints 96 and the guide member 82.

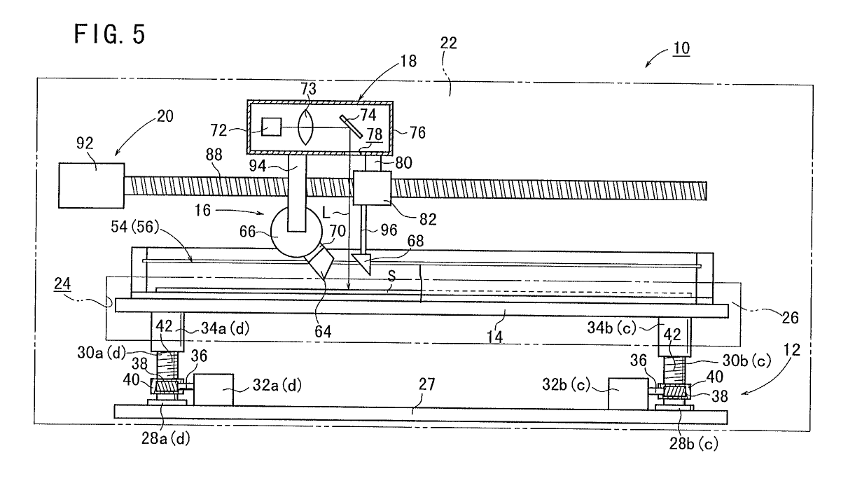

Stated otherwise, the light collecting device 16 is displaced in unison with the laser beam applying device 18, as shown in FIG. 5. Therefore, the laser beam L can be applied to the stimulable phosphor sheet S over its full length, and light emitted from the stimulable phosphor sheet S can be collected over its full length.

Finally, when the laser beam applying device 18 and the light collecting device 16 are displaced to the rear end of the stimulable phosphor sheet S, the process of reading the radiation image information from the image recording surface of the stimulable phosphor sheet S is finished.

As described above, since the lid 58 has been removed from the cassette casing 56, the image recording surface of the stimulable phosphor sheet S is exposed in its entirety. Therefore, when the laser beam applying device 18 and the light collecting device 16 are displaced to the rear end of the stimulable phosphor sheet S, the laser beam L has been applied to the entire image recording surface of the stimulable phosphor sheet S and light has been emitted from the entire image recording surface of the stimulable phosphor sheet S in response to the application of the laser beam L thereto. Accordingly, the radiation image information recorded in the entire image recording surface of the stimulable phosphor sheet S is read.

After the radiation image information recorded in the stimulable phosphor sheet S has been read, the cassette 54 is removed from the apparatus housing 22. If there is a danger that the light guide 64 and the reflecting mirror 68 may possibly hit the cassette casing 56 upon removal of the cassette 54 from the apparatus housing 22, then the lifting and lowering mechanism 12 is actuated to lower the support table 14. Thereafter, the shutter opening and closing mechanism is operated to lift the shutter 26, and the lid 58 is inserted into the cassette casing 56 along the grooves 60. Then, the cassette 54 is removed from the apparatus housing 22. Now, the stimulable phosphor sheet S is unloaded from the image information reading apparatus 10, and one cycle of image reading operation is finished.

The image information reading apparatus 10 according to the present invention is capable of reading the radiation image information from the stimulable phosphor sheet S without feeding the stimulable phosphor sheet S in the image information reading apparatus 10. As a result, the image information reading apparatus 10 is not required to incorporate a sheet handling mechanism for removing the stimulable phosphor sheet S from and inserting the stimulable phosphor sheet S into the cassette 54 and a sheet feeding mechanism for feeding the stimulable phosphor sheet S to a reading unit. Therefore, the image information reading apparatus 10 is much smaller and lighter than the conventional image information reading apparatus.

As the lid 58 of the cassette 54 is manually attached and detached by the operator, the image information reading apparatus 10 is not required to incorporate a lid opening and closing mechanism for opening and closing the lid 58. The image information reading apparatus 10 is thus relatively small in size and weight.

If remaining radiation image information is to be erased from the stimulable phosphor sheet S after the desired radiation image information has been read from the stimulable phosphor sheet S, then the stimulable phosphor sheet S is fed into an erasing unit where erasing light is applied to the image recording surface of the stimulable phosphor sheet S by an erasing light source. It is possible to record desired radiation image information on the stimulable phosphor sheet S from which unwanted remaining radiation image information has been erased.

In the above embodiment, the light collecting device 16 is coupled to the laser beam applying device 18 for displacement in unison therewith. However, the light collecting device 16 may be separate from the laser beam applying device 18 and may be displaced by a second displacing mechanism which has a motor that is energizable in synchronism with the motor 92 of the displacing mechanism 20.

The image information reading apparatus according to the above embodiment does not incorporate an erasing unit. However, the image information reading apparatus may incorporate an erasing unit having an erasing light source and a displacing mechanism for displacing the erasing light source. The displacing mechanism for displacing the erasing light source may comprise a motor and a ball screw, for example. When the erasing light source is displaced by the displacing mechanism, erasing light emitted from the erasing light source is applied to the stimulable phosphor sheet S over its entire length.

If the light collecting device 16 and the laser beam applying device 18 are capable of obtaining a good image from the stimulable phosphor sheet S without lifting or lowering the support table 14 with the cassette 54 placed thereon, then the image information reading apparatus may not incorporate the lifting and lowering mechanism 12.

Although a certain preferred embodiment of the present invention has been shown and described in detail, it should be understood that various changes and modifications may be made therein without departing from the scope of the appended claims.

What is claimed is:

1. An image information reading apparatus comprising:
a support table for placing thereon a container which houses a stimulable phosphor sheet with radiation image information recorded therein, with a lid openably and closably mounted on the container;
displaceable stimulating light applying means for applying stimulating light to the stimulable phosphor sheet which is exposed when said lid is opened;
displaceable light collecting means for collecting light which is emitted from said stimulable phosphor sheet upon exposure to said stimulating light; and
a photoelectric transducer mechanism for converting the collected light to an electric signal;
the arrangement being such that while said stimulating light applying means is facing and being displaced with respect to said stimulable phosphor sheet housed in said container, said stimulating light applying means applies said stimulating light to said stimulable phosphor sheet, and while said light collecting means is being displaced with respect to said stimulable phosphor sheet, said light collecting means collects light emitted from said stimulable phosphor sheet and reads radiation image information from the collected light.

2. An image information reading apparatus according to claim 1, wherein said stimulating light applying means and said light collecting means are coupled to each other for displacement in unison with each other.

3. An image information reading apparatus according to claim 2, further comprising:
a displacing mechanism for displacing said stimulating light applying means and said light collecting means, said displacing mechanism comprising a ball screw operatively connected to said stimulating light applying means and said light collecting means and a motor for rotating said ball screw about its own axis.

4. An image information reading apparatus according to claim 1, further comprising:
a lifting and lowering mechanism for lifting and lowering said support table.

5. An image information reading apparatus according to claim 4, wherein said lifting and lowering mechanism comprises a plurality of support shafts rotatably mounted on a base and operatively connected to said support table and a plurality of motors for rotating said support shafts respectively about their own axes to lift and lower said support table.

6. An image information reading apparatus according to claim 5, wherein said motors have respective rotatable shafts with respective worms fitted thereover, said support shafts supporting respective worm gears fitted thereover and held in mesh with said respective worms, whereby said support shafts can be rotated about their own axes by said worms and said worm gears when said motors are energized.

7. An image information reading apparatus according to claim 4, wherein said stimulating light applying means and said light collecting means are coupled to each other for displacement in unison with each other.

8. An image information reading apparatus according to claim 7, further comprising:
a displacing mechanism for displacing said stimulating light applying means and said light collecting means, said displacing mechanism comprising a ball screw operatively connected to said stimulating light applying means and said light collecting means and a motor for rotating said ball screw about its own axis.

9. An image information reading apparatus according to claim 1, wherein said container comprises a container casing with said lid being openably and closably mounted thereon, said lid being removably mounted on said container casing.

10. An image information reading apparatus according to claim 9, wherein said container casing has a groove defined therein, said lid having a side edge slidably fitted in said groove.

11. An image information reading apparatus according to claim 10, wherein said lid has a tab projecting from a side edge thereof.
